(19) United States
(12) Patent Application Publication
(10) Pub. No.: US 2013/0051796 A1
(43) Pub. Date: Feb. 28, 2013

(54) TRANSPONDER DEVICE, OPTICAL BRANCHING DEVICE, AND OPTICAL SIGNAL TRANSMISSION METHOD IN OPTICAL TRANSPORT NETWORK NODE

(71) Applicant: Yutaka YANO, Tokyo (JP)

(72) Inventor: Yutaka YANO, Tokyo (JP)

(73) Assignee: NEC Corporation, Tokyo (JP)

(21) Appl. No.: 13/594,475

(22) Filed: Aug. 24, 2012

(30) Foreign Application Priority Data
Aug. 26, 2011 (JP) 2011-185277

(51) Int. Cl. H04Q 11/00; H04B 10/08

(52) U.S. Cl. 398/34; 398/48

(57) ABSTRACT

A transponder device that can form D&C paths with great versatility and high reliability without complicating a device configuration is provided, as well as an optical branching device and an optical signal transmission method. The transponder device that is independent of any directions of a wavelength switching function section at a node in a WDM transport network includes a D&C branching means that branches an optical signal input from the wavelength switching function section into one stream of dropped light and at least one stream of continued light.

### INCORPORATION BY REFERENCE

This application is based upon and claims the benefit of priority from Japanese Patent Application No. 2011-185277, filed on Aug. 26, 2011, the disclosure of which is incorporated herein in its entirety by reference.

### BACKGROUND

The present invention relates to a transponder device in an optical transport network node and, more particularly, to a transponder device having drop and continue functionality as well as to an optical branching device and an optical signal transmission method.

Nodes in a wavelength division multiplexing (WDM) optical transport network have a wavelength switching function, capable of switching an optical signal as it is (without converting an optical signal into an electrical signal) to a desired direction or adding/dropping a client signal as it is. In general, a node having two degrees of direction (or two degrees) is called a re-configurable optical add drop multiplexer (ROADM) node, and a node having three or more degrees is called a wavelength cross-connect (WXC) node. However, since a node having two or more degrees is also called a multi-degree ROADM node recently, such nodes will collectively be referred to as ROADM (WXC) nodes hereinafter.

A ROADM (WXC) node is provided with a transponder (hereinafter, abbreviated as TPND where appropriate) for giving and receiving signals to/from a client side, in addition to a wavelength switching section for switching directions. The transponder has a function of sending out a transmission signal from the client side after transforming it into a main signal suitable for long-distance optical transmission, and of dropping a client signal from a main signal received by the node and giving it over to the client side. The connection between the transponder and the wavelength switching section was rather fixed in the past. However, colorless, direction-less, contention-less (CDC) ROADMs have become known as next-generation ROADMs and WXCs from which such a constraint is eliminated. “Colorless” means that the wavelength at a connection port between the transponder and the wavelength switching section is not limited; “direction-less” means that a direction connectable to the transponder is not limited; “contention-less” means that there is no case of blocking.

FIG. 1 is a block diagram showing a basic configuration of a typical CDC ROADM. A core portion of a wavelength switching section has a split (broadcast) and select configuration in general. Here, a wavelength selective switch WSS (N inputs M outputs) and a power splitter are provided for each of n directions, and transponder banks B1 to Bm for adding a transmission signal and dropping a reception signal are provided on the client side, whereby split (broadcast) and select is achieved. A prior transponder belonged to a direction in terms of management. In CDC ROADMs, on the other hand, a transponder can be connected to any direction and therefore is an independent presence, not belonging to any direction in terms of management. Such an adding/dropping function section or a client signal transceiver section that is not dependent on the directions is called an add/drop bank or a transponder bank. Accordingly, in the split (broadcast) and select configuration, each IF port distributes an externally input signal to all IF ports, and each of the IF ports, from the distributed signal, selects a signal addressed to itself and outputs it to the outside. Therefore, the split (broadcast) and select configuration is also called a full-mesh topology.

In such a split (broadcast) and select configuration, connecting a transponder bank to the core portion of the wavelength switch section is equivalent to adding a member of the split (broadcast) and select configuration (adding a direction), whereby great versatility can be achieved, and expansion of the functions or capacity can be facilitated. However, unlike a direction, there is no clear definition as to a unit of adding/removing a transponder bank, and an adequate size is chosen from an economic viewpoint. For example, at a node through which most of heavy traffic passes, the size of a transponder bank can be considerably small compared to the traffic passing through this node.

Incidentally, in a transport network, the majority are 1:1 communications in which a transmitter and a receiver make a pair, and 1:N communications or broadcast-type communications in which one transmitter makes transmission to a plurality of receivers are small in number. To implement broadcast-type communications in such a transport network, each node is provided with a special function called drop and continue (hereinafter, abbreviated as D&C). As shown in FIG. 2, the D&C function is a function, at each receiving-side node, of branching an optical signal received from a transmitting-side upstream node, receiving (dropping) one of branched optical signals at its own node, and transferring (continuing) the other branched signal to a downstream node.

For example, a technology for implementing the D&C function at an optical network node is disclosed in Japanese Patent No. 4361092. Moreover, according to an optical drop/add device disclosed in Japanese Patent Application Unexamined Publication No. 2006-087062 (see paragraph 0034 and others of Description), a path for allowing input light to pass through to an output port and a port for adding/dropping a desired-wavelength signal light to/from the input light are provided, whereby the D&C function is implemented without disrupting transmission signals.

However, nodes in an optical transport network that provide the D&C function handling an optical signal as it is have the following problems.

First, since a dedicated portion for implementing the D&C function is not independent of the optical switch core portion, versatility of the split (broadcast) and select configuration shown in FIG. 1 is impaired.

If an intention is made to implement the D&C function without impairing versatility of the configuration as shown in FIG. 1, it is conceivable to make changes in the transponders of the transponder banks B1 to Bm as follows. Specifically, at a node that only continues a main signal like the receiving-side node N2 in FIG. 2, a received signal is turned round and transmitted by using a transponder card 1 for regenerative repeating as shown in FIG. 3A. At a node that drops and continues a main signal like the receiving-side node N1 or N3 in FIG. 2, with the provision of an optical branching section 3 on the client side of an ordinary transponder card 2 as shown in FIG. 3B to branch a signal to be transmitted to the client side, branched light to drop is output to the client side, and branched light to continue is turned round to the transponder card 2 and transmitted to the WDM side.

In the transponder card 1 for regenerative repeating shown in FIG. 3A, two ordinary transponder cards are used back to back, thereby achieving regenerative repeating. In this case, the client-side interfaces are wasted. Therefore, there are some cases that, omitting such interfaces, cards specifically designed for regenerative repeating are lined up.

According to the regenerative-repeating-type D&C configuration shown in FIG. 3B, the D&C configuration can be implemented only by adding the optical branching section 3 to the ordinary transponder card 2. Moreover, this regenerative-repeating-type D&C configuration has the advantage that the certainty of signal transmission is increased because a continued signal is regenerative-repeated. However, a delay is increased because a transmission signal to the client side is turned round and then further transformed into a transmission signal on the WDM side for transmission. In addition, it is necessary to provide a transceiver on each of the WDM and client sides, complicating a device configuration for implementing the D&C configuration, resulting in it being difficult to achieve cost reduction. Furthermore, since light is branched and turned round at a halfway point of the client-side interface, it is difficult to compensate for loss due to branching of light, causing problems such as lowering the power level and shortening the connection distance. Moreover, considerations need to be given to securing a space to accommodate the optical branching section 3, installing an optical connector junction, and the like, presenting the drawback that the degree of freedom of design is greatly reduced. Further, another disadvantage is that incidents such as an improper connection and a disconnection cannot be adequately monitored although such incidents possibly occur because optical branching parts are detachable but are excluded from subjects of monitoring.

Moreover, from the viewpoint of network management, when the D&C configuration is adopted, special considerations need to be given to network management because network management systems (NMS) are modeled on 1:1 communications. That is, one of the main roles of NMS is to manage paths on a network, and a basic path model is a 1:1 communication model. Therefore, beginning with a screen display and the like, many special considerations are required to handle a 1:N communication model. If a network is of a specialized broadcast type, a specialized NMS is prepared. However, it is preferable to avoid specially handling a 1:N communication model, which is a fraction of communications in a network where the majority are 1:1 communications.

Accordingly, an object of the present invention is to provide a transponder device, a optical branching device, and an optical signal transmission method that can form D&C paths with great versatility and high reliability, without complicating a device configuration.

### SUMMARY

According to the present invention, a transponder device which is independent of any directions of a wavelength switching section in a node of a wavelength division multiplexing transport network, includes: an optical branching section for branching an optical signal input from the wavelength switching section into one reception light and at least one transmission light.

According to the present invention, an optical branching device which is independent of any directions of a wavelength switching section in a node of a wavelength division multiplexing transport network, includes: an optical branching section for branching an optical signal input from the wavelength switching section into one reception light and at least one transmission light; and an optical connector for detachably connecting the optical branching section with a receiver-transmitter section which receives the reception light and transmitting it as a client signal.

According to the present invention, a method for transmitting an optical signal in a transponder device which is independent of any directions of a wavelength switching section in a node of a wavelength division multiplexing transport network, includes the steps of: branching the optical signal input from the wavelength switching section into a plurality of branched lights; and transmitting one branched light as reception light to a transponder section and at least one other branched light as transmission light to a downstream node.

According to the present invention, it is possible to form D&C paths with great versatility and high reliability, without complicating a device configuration

### BRIEF DESCRIPTION OF THE DRAWINGS

FIG. 1 is a block diagram showing a basic configuration of a typical CDC ROADM.

FIG. 2 is a network diagram to describe a D&C function.

FIG. 3A is a block diagram showing an example of a transponder card for repeating.

FIG. 3B is a block diagram showing a regenerative-repeating-type D&C configuration using an ordinary transponder card.

FIG. 4 is a block diagram showing a D&C transponder device according to a first illustrative embodiment of the present invention.

FIG. 5 is a block diagram showing a D&C branching device and a transponder device in a D&C transponder device according to a second illustrative embodiment of the present invention.

FIG. 6 is a network diagram to describe a D&C function in an optical transport network using the D&C transponder device according to any one of the illustrative embodiments.

### DETAILED DESCRIPTION

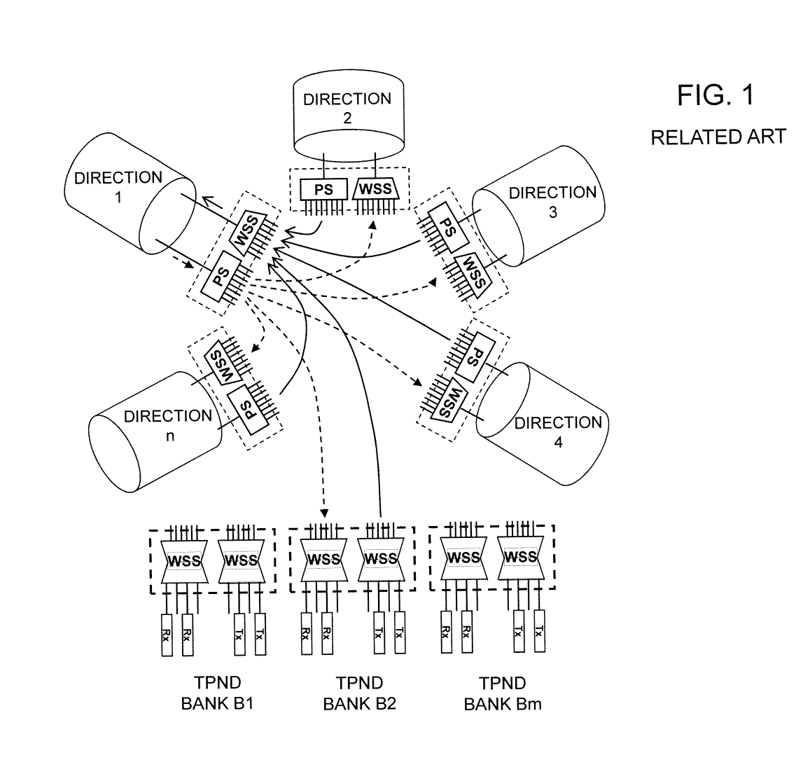

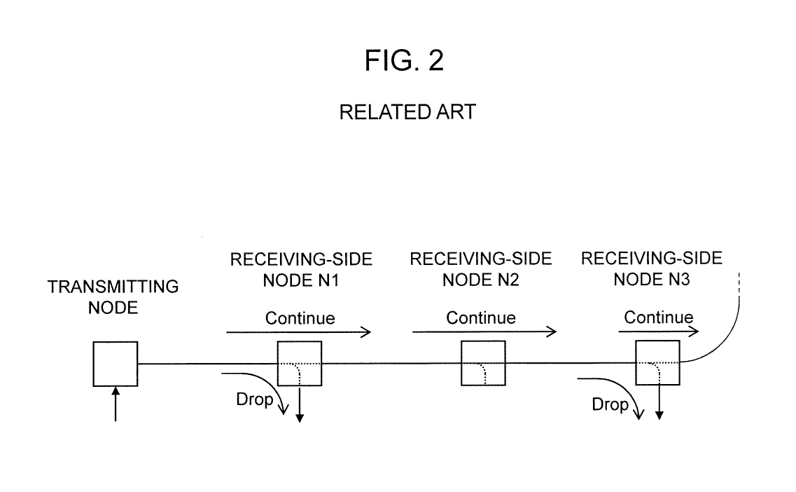

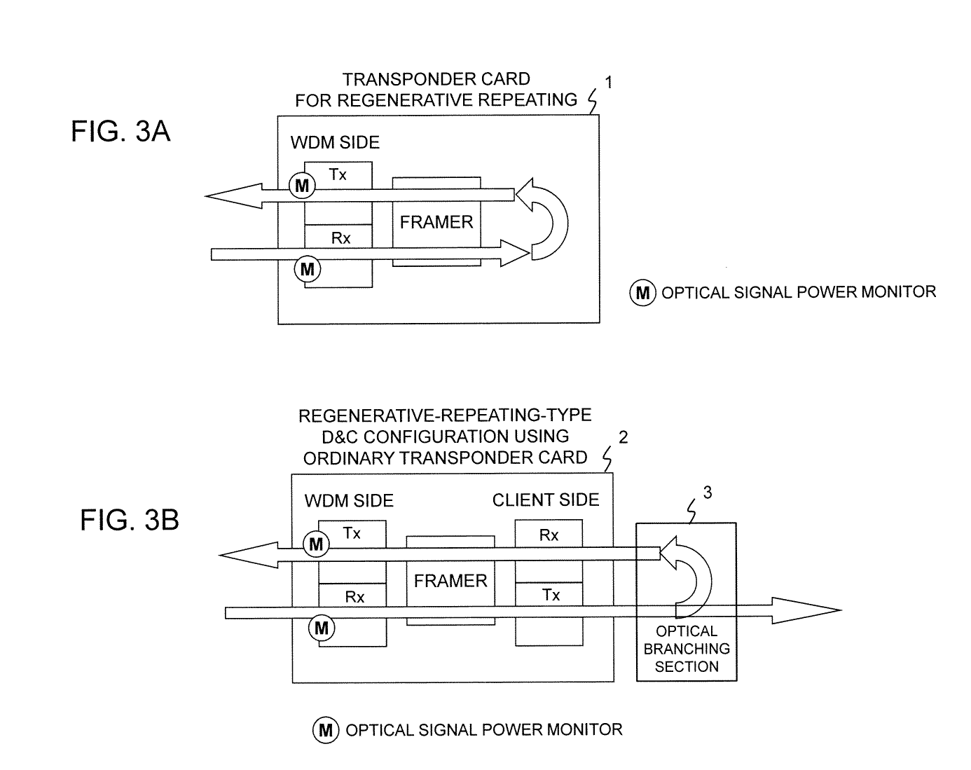

According to the present invention, a D&C optical branching function section is placed in a previous stage to a transceiver function section on a client side, whereby it is possible to form highly reliable D&C paths, without impairing versatility of the split (broadcast) and select configuration shown in FIG. 1, and without complicating a device configuration. Hereinafter, illustrative embodiments of the present invention will be described in detail, referring to the accompanying drawings.

### 1. First Illustrative Embodiment

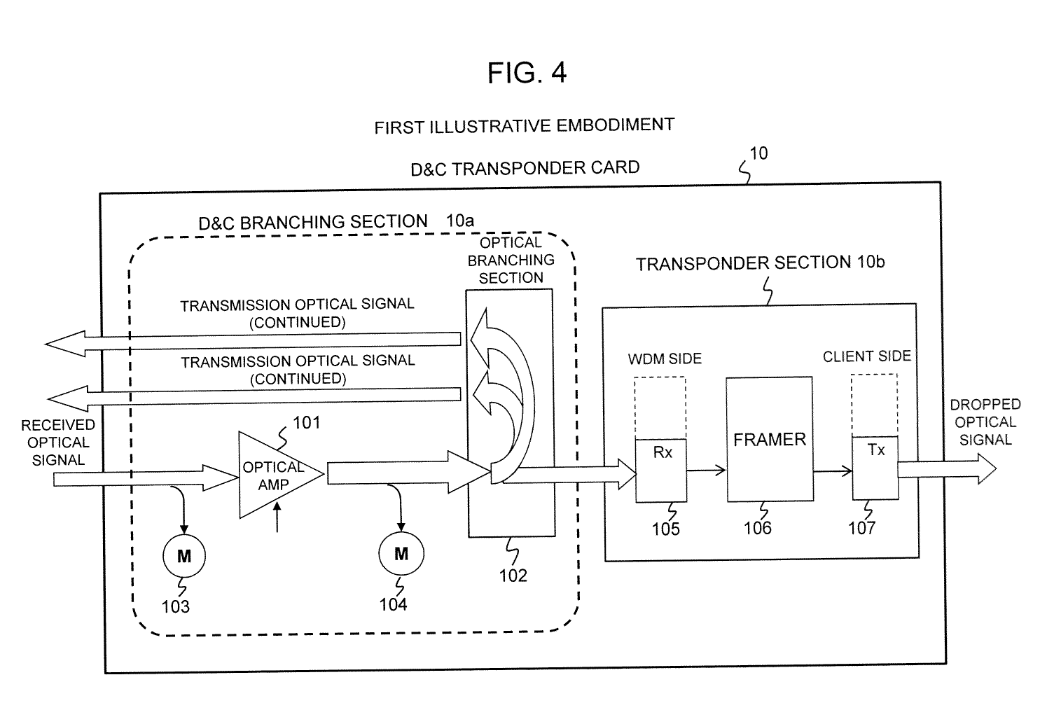

Referring to FIG. 4, a D&C transponder card 10 according to a first illustrative embodiment of the present invention includes a D&C branching section 10a that constructs D&C paths and compensates for loss due to branching of light and a transponder section 10b, and has a card form that can be mounted, as it is, into a transponder bank of the split (broadcast) and select configuration shown in FIG. 1. A transmitted optical signal is branched into two or more streams of light at the D&C branching section 10a, and one of them enters the transponder section 10b, from which received data is output (dropped) to the client side, while the other branched stream(s) of light, as it stays an optical signal, is turned round to be an optical signal output, which is then transmitted (continued) to a downstream node.

The D&C branching section 10a includes an optical amplifier 101, an optical branching section 102, and optical power monitors 103 and 104. The optical amplifier 101, which is provided to compensate for a level reduction due to branching of light, amplifies a received optical signal and outputs it to an input port of the optical branching section 102. The optical branching section 102, which has three output ports as an example, outputs an optical signal to the transponder section 10b from one of the output ports and outputs two transmission optical signals to downstream nodes from the other two output ports, respectively.

Moreover, the optical power monitor 103 monitors whether or not a received optical signal has arrived with a predetermined level of optical power, and the optical power monitor 104 monitors the power of an optical signal to be input from the optical amplifier 101 into the input port of the optical branching section 102. Normality of the reception power and transmission power on WDM side are monitored by the optical power monitors 103 and 104. Monitoring signals of the optical power monitor 104 and of an optical power monitor subsequent thereto may be fed back to control the rate of amplification by the optical amplifier 101, thereby adjusting the level of power on the client side within a normal range. Since the optical amplifier 101 and optical branching section 102 are connected inside the D&C transponder card 10, improper connections can be prevented.

The transponder section 10b includes at least a receiver 105 as a WDM-side interface, at least a transmitter 107 as a client-side interface, and a flamer 106 that pulls a received signal into frame synchronization and outputs it to the transmitter 107. The client-side interface is an optical interface that is standardized, compatible with different venders' devices, and relatively low priced. The WDM-side interface is an optical interface that is uniquely developed, compatible with only a single type of a single vender, and relatively high priced.

Note that the optical branching section 102 may have two or more branches for “continue”, in which case a continued signal can be branched and sent to a plurality of downstream nodes. In the present illustrative embodiment, since a function of receiving a signal from the client side and transmitting it to the WDM side is not required, an electric circuit for that function is omitted, whereby it is possible to achieve cost reduction, as well as to achieve lower power consumption.

### 2. Second Illustrative Embodiment

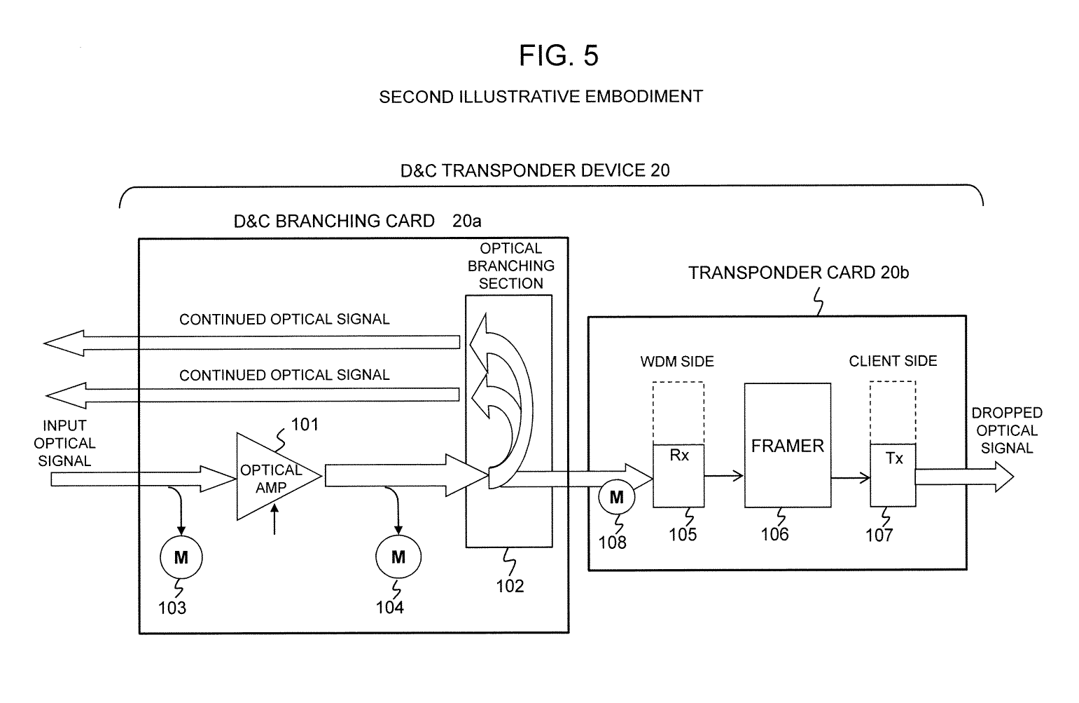

Referring to FIG. 5, a D&C transponder device 20 according to a second illustrative embodiment of the present invention is different from the above-described first illustrative embodiment in that it is of a separation type, in which a D&C branching card 20a that constructs D&C paths and compensates for loss due to branching of light and a transponder card 20b that is a transceiver function section are separated from each other and configured to be connectable through an optical connector. The D&C branching card 20a has a card form that can be mounted, as it is, into a transponder bank of the split (broadcast) and select configuration shown in FIG. 1. Since individual inner constituents are the same as those of the first illustrative embodiment shown in FIG. 4, the same reference numerals as in FIG. 4 are used, and a description thereof will be omitted. However, since the transponder card 20b is separated, a reception power monitor 108 is added to a reception port thereof, as in an ordinary transponder card.

The D&C branching card 20a, including the optical amplifier 101 and the optical branching section 102, is of an all light type and is not dependent on the type of an optical signal. Accordingly, for example, if the capacity of D&C paths originally for a gigabit Ethernet 7 (GbE) signal is increased to 10 GbE, the D&C branching card 20a can continue to be used. Moreover, since the D&C branching card 20a can be mounted as it is into a transponder bank of the split (broadcast) and select configuration shown in FIG. 1, it is possible to easily change the capacity of D&C paths, without impairing versatility of the split (broadcast) and select configuration. Even if the capacity of D&C paths is increased as described above, it sufficient to change only the transponder card 20b to a larger-capacity one, with the D&C branching card 20a kept connected (hence without disrupting continued light).

Moreover, if the transponder card 20b is removed, remained is only the light branch(s) at the D&C branching card 20a. Therefore, it is possible to optically branch an input optical signal and allow it to continue. In this case, dropped light obtained by the optical branching section 102 is wasted, but when desiring to receive such a dropped signal, regeneration of the reception signal can be accomplished only by connecting the transponder card 20b, without causing a temporary disconnection of the continued light.

Note that also in the present illustrative embodiment, as in FIG. 4, a function of receiving a signal from the client side and transmitting it to the WDM side is omitted from the transponder card 20b to achieve cost reduction and lower power consumption. However, according to the present illustrative embodiment, since the D&C branching card 20a and the transponder card 20b are detachably separated from each other, there is another advantage that an ordinary transponder card can be used as it is to be mounted into a transponder bank of the split (broadcast) and select configuration shown in FIG. 1.

As described above, the D&C branching card 20a can be mounted as it is into a transponder bank of the split (broadcast) and selection configuration shown in FIG. 1. Therefore, by connecting the transponder card 20b to the D&C branching card 20a, it is possible to benefit from the merits of CDC ROADM in establishment and maintenance of D&C paths. For example, a configuration can be made such that a standby D&C branching card 20a is installed beforehand in a transponder bank, and when a demand arises, the standby D&C branching card 20a is remotely connected to start to be used.

### 3. Optical Transport Network

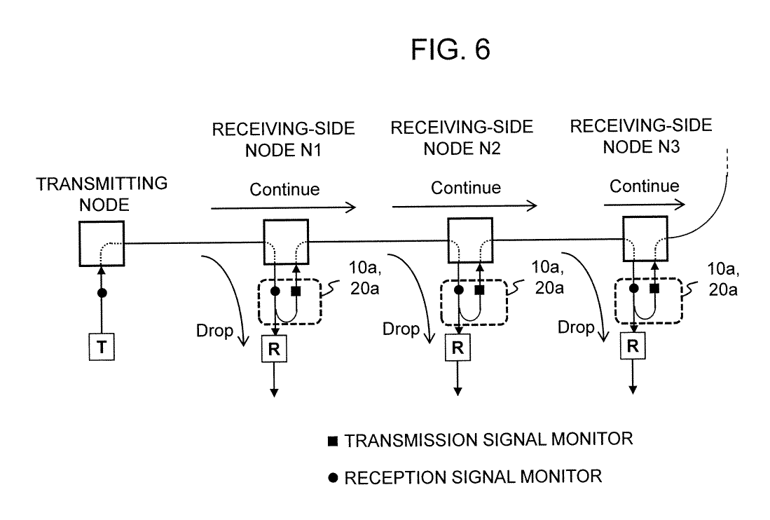

Referring to FIG. 6, the D&C branching function section (D&C branching section 10a or D&C branching card 20a) of any one of the above-described first and second illustrative embodiments of the present invention is installed in each of transponder banks of receiving-side nodes N1 to N3, whereby a main signal from a transmitting node can be passed through (continued) and, if necessary, can be received (dropped) through a transponder card R. In this event, it is possible to apply a reception power management model similar to that of an ordinary transponder card because the reception signal monitor (optical power monitor 103) is provided to the D&C branching function section. Moreover, since the transmission signal monitor (optical power monitor 104) and the optical amplifier 101 are provided, it is possible to compensate for an attenuation of the power of branched light and control it within a predetermined stipulated range.

Only by installing the D&C branching function section into a transponder bank in this manner, it is possible to easily establish highly reliable D&C paths, without complicating a device configuration.

### 4. Advantageous Effects

As described above, according to any one of the first and second illustrative embodiments of the present invention, it is possible to install the D&C transponder card 10 or D&C branching card 20a at an arbitrary place with an arbitrary wavelength in arbitrary numbers, like a transponder of a transponder bank. By installing the D&C transponder card 10 or D&C branching card 20a in a transponder bank, it is possible to derive the benefit of the characteristics of CDC ROADM (i.e., colorless, direction-less, contention-less) for D&C paths. Such a degree of freedom cannot be obtained if the D&C function section is incorporated into the ROADM section or WXC section.

Moreover, since any one of the D&C transponder card 10 and the D&C branching card 20a is provided with the optical power monitors 103 and 104, it is possible to apply a reception power management model similar to that of an ordinary transponder card. That is, since it is possible to represent D&C paths with a 1:1 communication model as shown in FIG. 6, management by NMS is facilitated.

As described above, the D&C function section is made in a card form that is independent of the optical switch core portion and is mounted into a transponder bank, whereby it is possible for D&C paths to obtain the merits of CDC ROADM similarly to ordinary paths, without impairing versatility of the ROADM (WXC) section. Moreover, it is possible to remotely make a connection and a change, and it is possible to construct D&C paths to resemble a 1:1 communication model (ordinary TPND) as shown in FIG. 6. Therefore, special considerations are not required for management by NMS. Further, owing to the optical amplifier, it is possible to compensate for loss due to branching of light, and owing to feedback control by the optical power monitors, it is possible to maintain the power of branched light at a normal level.

The present invention is applicable to a ROADM/WXC node in a WDM optical transport network. The present invention may be embodied in other specific forms without departing from the spirit or essential characteristics thereof. The above-described illustrative embodiment and examples are therefore to be considered in all respects as illustrative and not restrictive, the scope of the invention being indicated by the appended claims rather than by the foregoing description, and all changes which come within the meaning and range of equivalency of the claims are therefore intended to be embraced therein.

1. A transponder device which is independent of any directions of a wavelength switching section in a node of a wavelength division multiplexing transport network, comprising:
an optical branching section for branching an optical signal input from the wavelength switching section into one reception light and at least one transmission light.

2. The transponder device according to claim 1, further comprising:
a receiver-transmitter section for receiving the reception light and transmitting it as a client signal.

3. The transponder device according to claim 2, wherein the optical branching section and the receiver-transmitter section are detachably connected.

4. The transponder device according to claim 2, wherein the transponder device is mounted to a transponder bank of an optical add/drop node which is independent of a wavelength or a direction of the optical signal.

5. The transponder device according to claim 1, further comprising:
an input light monitor for monitoring an optical power level of the optical signal; and
an optical amplifier for amplifying the optical signal to output an amplified optical signal to the optical branching section.

6. The transponder device according to claim 5, further comprising:
an output light monitor for monitoring an optical power level of at least the reception light; and
wherein a gain of the optical amplifier is controlled based on a monitor result of the output light monitor.

7. An optical branching device which is independent of any directions of a wavelength switching section in a node of a wavelength division multiplexing transport network, comprising:
an optical branching section for branching an optical signal input from the wavelength switching section into one reception light and at least one transmission light; and
an optical connector for detachably connecting the optical branching section with a receiver-transmitter section which receives the reception light and transmitting it as a client signal.

8. The optical branching device according to claim 7, further comprising:
an input light monitor for monitoring an optical power level of the optical signal; and
an optical amplifier for amplifying the optical signal to output an amplified optical signal to the optical branching section.

9. The optical branching device according to claim 8, further comprising:
an output light monitor for monitoring an optical power level of at least the reception light; and
wherein a gain of the optical amplifier is controlled based on a monitor result of the output light monitor.

10. The optical branching device according to claim 7, wherein the optical branching device is mounted to a transponder bank in an optical add/drop node which is independent of a wavelength or a direction of the optical signal.

11. A method for transmitting an optical signal in a transponder device which is independent of any directions of a wavelength switching section in a node of a wavelength division multiplexing transport network, comprising:
branching the optical signal input from the wavelength switching section into a plurality of branched lights; and
transmitting one branched light as reception light to a transponder section and at least one other branched light as transmission light to a downstream node.

12. The method according to claim 11, further comprising:
monitoring an optical power level of the optical signal; and
amplifying the optical signal to output an amplified optical signal to the optical branching section.

13. The method according to claim 12, further comprising:
monitoring an optical power level of at least the reception light; and
controlling a gain of the optical amplifier based on a monitor result of the reception light.

14. A multi-degree ROADM (Reconfigurable Optical Add Drop Multiplexer) node comprising the transponder device according to claim 1.

15. A multi-degree ROADM (Reconfigurable Optical Add Drop Multiplexer) node comprising the optical branching device according to claim 7.
